(19) United States
(12) Patent Application Publication
(10) Pub. No.: US 2026/0140425 A1
(43) Pub. Date: May 21, 2026

(54) Monitor Having Charging Effect

(71) Applicant: Dongguan Miles Precision Manufacturing Co., Ltd, Dongguan (CN)

(72) Inventor: Jun Ouyang, Dongguan (CN)

(21) Appl. No.: 18/967,631

(22) Filed: Dec. 3, 2024

(30) Foreign Application Priority Data
Nov. 19, 2024 (CN) 202422824882.5
Nov. 19, 2024 (CN) 202422824906.7

(51) Int. Cl. G03B 7/26; G03B 17/56

(52) U.S. Cl. CPC G03B 7/26; G03B 17/561

(57) ABSTRACT

Disclosed is a monitor having a charging effect. The monitor includes a housing, a monitor main body and a power supply module, wherein the monitor main body is mounted to the housing, the power supply module includes a battery, a power supply circuit board and a power supply connection line, and the battery and the power supply circuit board are both connected to the monitor main body; and one end of the power supply connection line is electrically connected to the power supply circuit board, and the other end of the power supply connection line penetrates the housing to form an interface for connecting a camera. By providing a shutter control module on a monitor, the camera can be controlled to perform shooting by the shutter control module, such that a photographer can monitor and photograph a photographic picture on the monitor simultaneously, which is convenient to use.

### CROSS REFERENCE TO RELATED APPLICATIONS

The present application claims the benefit of Chinese Patent Application Nos. 202422824882.5 and 202422824906.7 filed on November 19, 2024. All the above are hereby incorporated by reference in their entirety.

### TECHNICAL FIELD

The present disclosure is in the field of photographic accessories and in particular relates to a monitor having a charging effect.

### BACKGROUND ART

Photographic equipment usually requires the use of a photographic monitor in order to facilitate better real-time viewing of shooting pictures by personnel, since the screen of the camera itself is usually small at the time of photographing.

The photographic monitor can feed back a shooting picture of the camera through a relatively large screen in real time, provide high-definition image preview, help photographers and directors view the shooting picture in real time, and ensure that picture composition, exposure, color, etc. meet expectations.

An existing photographic monitor can usually only feed back the shooting picture of the camera, and when viewing the shooting picture through the monitor, the personnel usually needs to control a camera shutter to perform photographing, and at this time, it is necessary to operate the two devices of the camera and the monitor at the same time, which is inconvenient to use;

At the same time, an existing camera usually has its own battery to supply power to itself and matching photographic accessories, but the existing camera simply relies on the camera to supply power when used, leading to the problem of insufficient endurance. However, some existing photographic monitors are not provided with a power source, and the camera is required to supply power during use, which will shorten the endurance of the camera; some existing photographic monitors have batteries, but they cannot supply power to the camera and cannot improve the endurance time of the camera.

### SUMMARY OF THE INVENTION

In order to solve the above-mentioned problems, it is a primary object of the present disclosure to provide a monitor having a charging effect, which can control a camera to perform photographing by the monitor and is convenient to use.

Another object of the present disclosure is to provide a monitor having a charging effect, which can supply power to a camera and improve anendurance time of the camera.

To achieve the above-mentioned objects, the present disclosure adopts the following technical solutions:

The present disclosure provides a monitor having a charging effect, including: a housing, a monitor main body and a power supply module, wherein the power supply module includes a battery, a power supply circuit board and a power supply connection line, and the battery and the power supply circuit board are both connected to the monitor main body; and one end of the power supply connection line is electrically connected to the power supply circuit board, and the other end of the power supply connection line penetrates the housing to form an interface for connecting a camera.

Further, a battery compartment is further provided on the housing, the power supply module further includes a powered PCB board and a sealing rear cover, and the battery is provided in the battery compartment, and is electrically connected to the monitor main body; a connection port is provided at an outer side of the battery compartment, and the powered PCB board is located in the connection port and is electrically connected to the battery and the monitor main body so as to achieve series connection between several batteries; and the sealing rear cover is provided on an outer side of the powered PCB board and is detachably connected to an inner wall of the connection port.

Further, a threaded member is provided on the sealing rear cover, a screw hole is provided on the inner wall of the connection port, a control handle is further provided on an outer side of the sealing rear cover, and one end of the threaded member is threadedly connected to the screw hole and the other end of the threaded member is fixedly connected to the control handle.

Further, a sealing ring is provided between the sealing rear cover and the inner wall of the connection port.

Further, the monitor having a charging effect further includes a shutter control module, the monitor main body is mounted to the housing, and the shutter control module includes a shutter control circuit board, a shutter control button, and a signal transmission unit, wherein the shutter control circuit board is mounted to the housing, the shutter control button is exposed to the housing, and the shutter control button and the signal transmission unit are both connected to the shutter control circuit board.

Further, the shutter control button includes a handle, a connection rod, a torsion spring, and a trigger, wherein the handle is exposed outside the housing; the connection rod is movably connected to the housing, and one end of the connection rod is fixedly connected to the handle and the other end of the connection rod is fixedly connected to the trigger; the torsion spring is sheathed on the connection rod; and one end, away from the connection rod, of the trigger is provided with a protruding post, the shutter control circuit board is provided with a control key, and the protruding post is provided opposite the control key.

Further, the housing is provided with a through hole, the connection rod is provided through the through hole, and a sealing member is further provided between the through hole and the connection rod.

Further, the signal transmission unit employs a shutter line, one end of the shutter line is electrically connected to the shutter control circuit board, the other end of the shutter line is provided with a shutter interface, and the shutter interface forms the interface for connecting the camera through the housing.

Further, the monitor main body includes a main control circuit board, a display screen control circuit board, a display screen and a video signal line, the main control circuit board and the display screen control circuit board are both mounted in the housing, the display screen is mounted and exposed to the housing, the display screen control circuit board, the shutter control circuit board, the battery, the power supply circuit board and the powered PCB board are all electrically connected to the main control circuit board, and the display screen is electrically connected to the display screen control circuit board; and one end of the video signal line is connected to the display screen control circuit board, and the other end of the video signal line penetrates the housing to form the interface for connecting the camera.

Further, the monitor main body further includes a monitoring adjustment button having a lower end provided above the main control circuit board and an upper end penetrating and exposed outside the housing.

Further, a first interface is provided on the housing, the shutter line and the power supply connection line are exposed outside the housing through the first interface, a first waterproof sleeve is connected to the first interface, and the first waterproof sleeve is sheathed outside the shutter line and the power supply connection line.

Further, a second interface is provided on the housing, the video signal line is exposed outside the housing through the second interface, a second waterproof sleeve is connected to the second interface, and the second waterproof sleeve is sheathed outside the video signal line.

Further, both an upper end and a lower end of the housing are provided with fixing members for fixing the monitor to other structures.

Compared to the prior art, the advantageous effects of the present disclosure are: in the present disclosure, by providing a shutter control module on a monitor, in use, the camera can be controlled to perform shooting by the shutter control module, such that a photographer can monitor and photograph a photographic picture on the monitor at the same time, which is convenient to use;

Furthermore, a power supply module is provided in the monitor, which can supply power to the camera and improve endurance capability of the camera.

### BRIEF DESCRIPTION OF THE DRAWINGS

FIG. 1 is a schematic structural diagram of a monitor from a first perspective.

FIG. 2 is a schematic structural diagram of the monitor from a second perspective.

FIG. 3 is a schematic structural diagram of a housing from a first perspective.

FIG. 4 is a schematic structural diagram of the housing from a second perspective.

FIG. 5 is a schematic structural diagram of the monitor after the housing, a first waterproof sleeve and a second waterproof sleeve are hidden.

FIG. 6 is a schematic structural diagram of a shutter control module.

FIG. 7 is an exploded diagram of the shutter control module.

FIG. 8 is a schematic structural diagram of a power supply module.

FIG. 9 is an exploded diagram of the power supply module.

In the drawings: 1, housing; 11, through hole; 12, battery compartment; 13, connection port; 14, screw hole; 15, first interface; 16, second interface; 2, monitor main body; 21, main control circuit board; 22, display screen control circuit board; 23, display screen; 24, video signal line; 25, monitoring adjustment button; 3, shutter control module; 31, shutter control circuit board; 311, control key; 32, shutter control button; 321, handle; 322, connection rod; 323, torsion spring; 324, trigger; 325, protruding post; 326, sealing member; 33, signal transmission unit; 4, power supply module; 41, battery; 42, power supply circuit board; 43, power supply connection line; 44, powered PCB board; 45, sealing rear cover; 46, threaded member; 47, control handle; 5, first waterproof sleeve; 6, second waterproof sleeve; 7, fixing member.

### DETAILED DESCRIPTION OF THE INVENTION

In order that the objects, technical solutions and advantages of the present disclosure may be more clearly understood, the present disclosure will be described in further detail below in combination with the accompanying drawings and the embodiments. It should be understood that the particular embodiments described herein are illustrative only and are not restrictive.

To achieve the above-mentioned objects, the present disclosure adopts the following technical solutions:

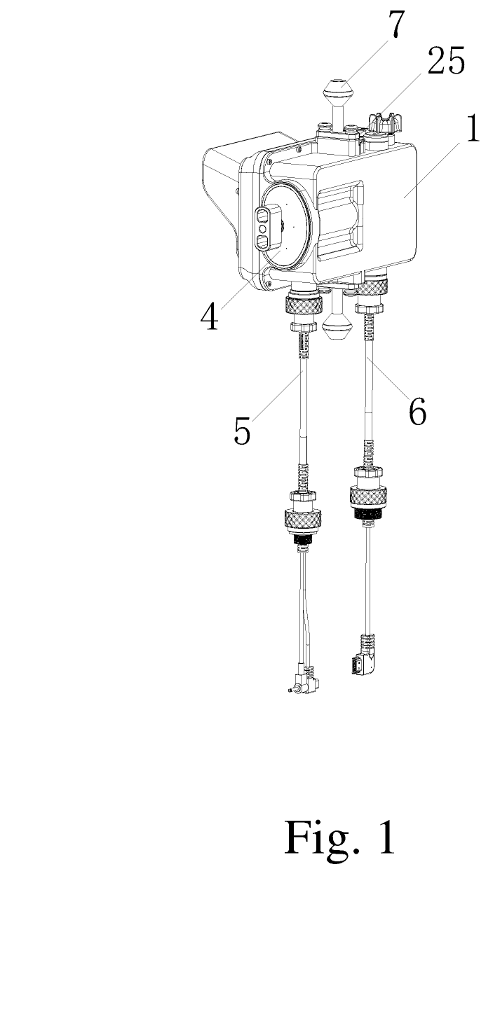

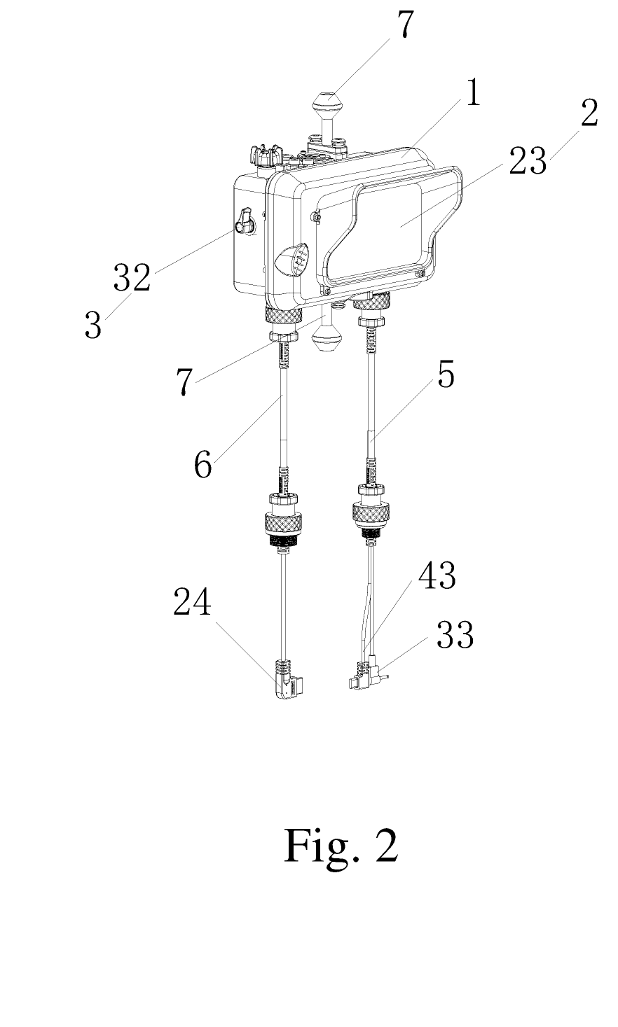

With reference to FIGS. 1 and 2, the present embodiment provides a monitor having a charging effect, connected to a camera, for feedback of a real-time picture taken by the camera, including:a housing 1, a monitor main body 2 and a shutter control module 3, wherein the monitor main body 2 is mounted to the housing 1, the shutter control module 3 includes a shutter control circuit board 31, a shutter control button 32 and a signal transmission unit 33, the shutter control circuit board 31 is mounted to the housing 1, the shutter control button 32 is exposed to the housing 1, and the shutter control button 32 and the signal transmission unit 33 are both connected to the shutter control circuit board 31.

In the present disclosure, in use, the shutter control circuit board 31 can be triggered by the shutter control button 32 to generate a shutter control signal, and the shutter control signal is transmitted to the camera via the signal transmission unit 33 to control the camera shooting, so as to integrate a shooting function of the camera into the monitor, which is convenient to use.

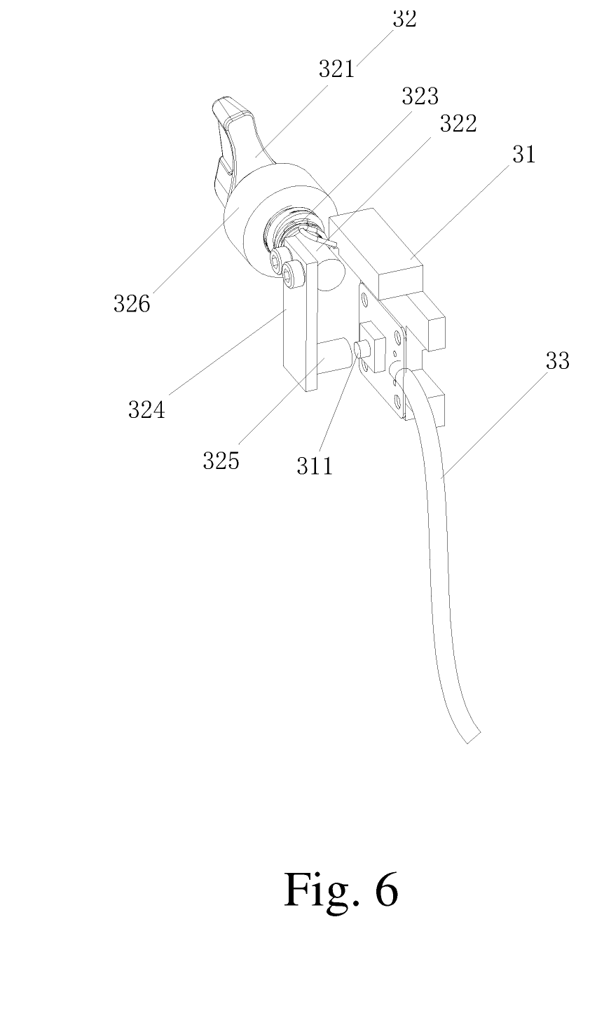

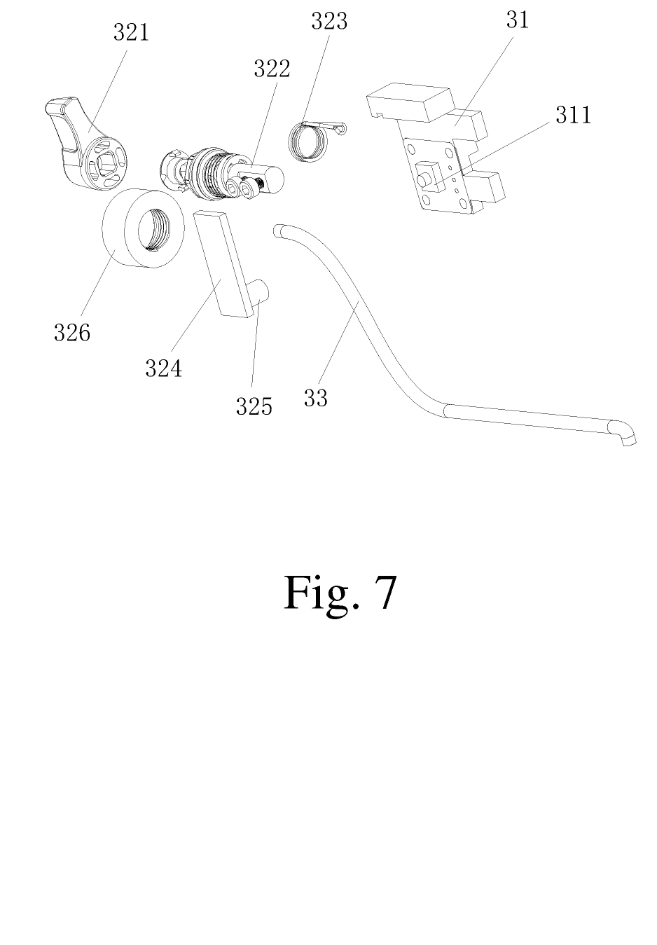

Further, with reference to FIGS. 6-7, the shutter control button 32 includes a handle 321, a connection rod 322, a torsion spring 323, and a trigger 324, wherein the handle 321 is exposed outside the housing 1; the connection rod 322 is movably connected to the housing 1, and one end of the connection rod 322 is fixedly connected to the handle 321 and the other end of the connection rod 322 is fixedly connected to the trigger 324; the torsion spring 323 is sheathed on the connection rod 322; and one end, away from the connection rod 322, of the trigger 324 is provided with a protruding post 325, the shutter control circuit board 31 is provided with a control key 311, and the protruding post 325 is provided opposite the control key 311. In the present disclosure, when the handle 321 is dialed outside the housing 1, the connection rod 322 can be driven to rotate, and then the trigger member 324 is driven to swing with the connection rod 322 as a shaft, the protruding post 325 approaches and presses and presses the control key 311 and triggers the shutter control circuit board 31 to generate the shutter control signal; and when the handle 321 is released, the connection rod 322 is reset by an elastic force of the torsion spring 323, and the protruding post 325 is disengaged from the control key 311.

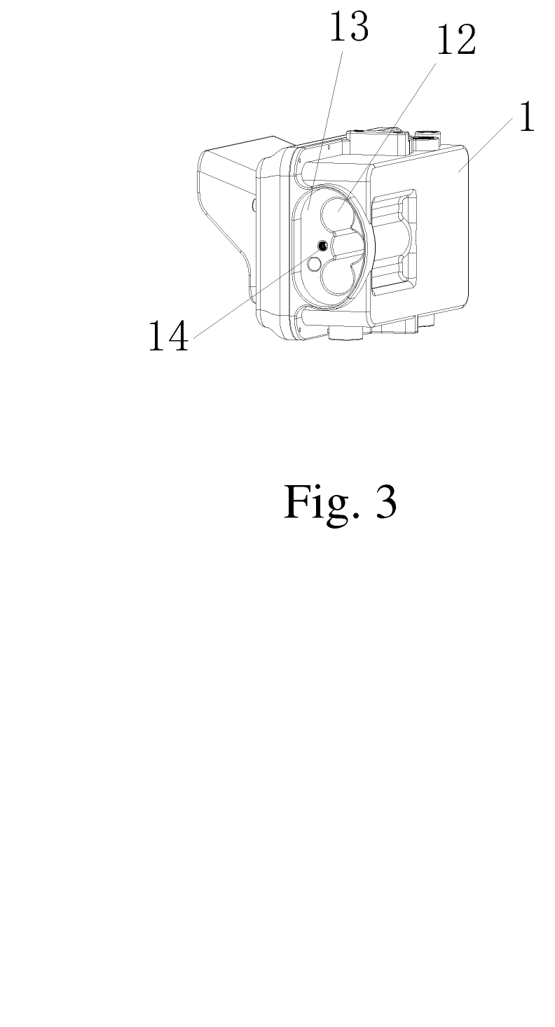

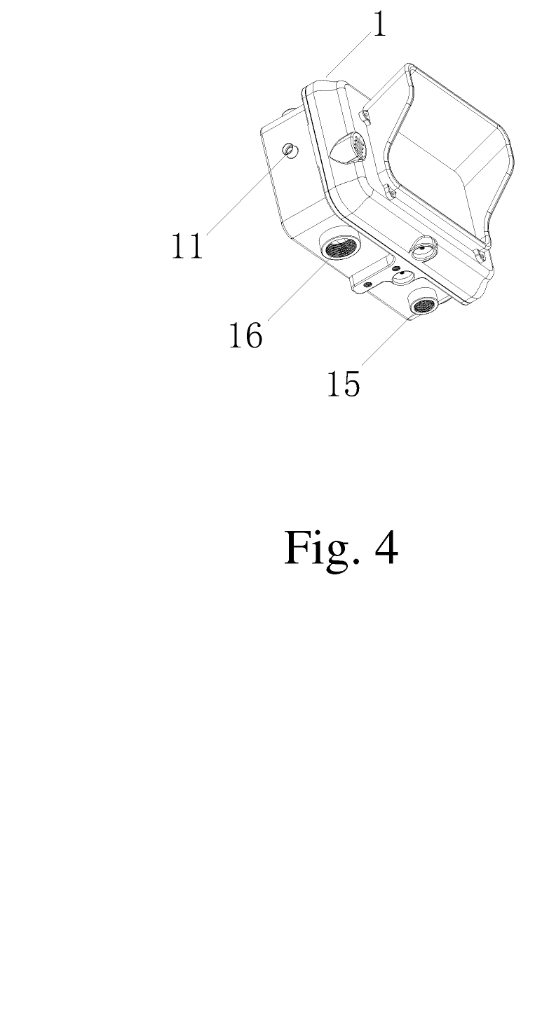

Further, referring to FIGS. 3-4, the housing 1 is provided with a through hole 11, the connection rod 322 is provided through the through hole 11, and a sealing member 326 is further provided between the through hole 11 and the connection rod 322.

Further, the signal transmission unit 33 employs a shutter line, one end of the shutter line is electrically connected to the shutter control circuit board 31, the other end of the shutter line is provided with a shutter interface, and the shutter interface forms the interface for connecting the camera through the housing 1. The shutter interface can use common interfaces such as type-c and USB to be connected with the camera, transmit the shutter control signals to the camera, and achieve the control of camera shooting.

Note that the signal transmission unit 33 of the present embodiment may be connected to the camera by means of wireless transmission to achieve wireless control of the camera shutter. Wireless transmission means including but not limited to Bluetooth, Wi-Fi, radio frequency, infrared, sonar, etc. shall be within the scope of protection of the present embodiment.

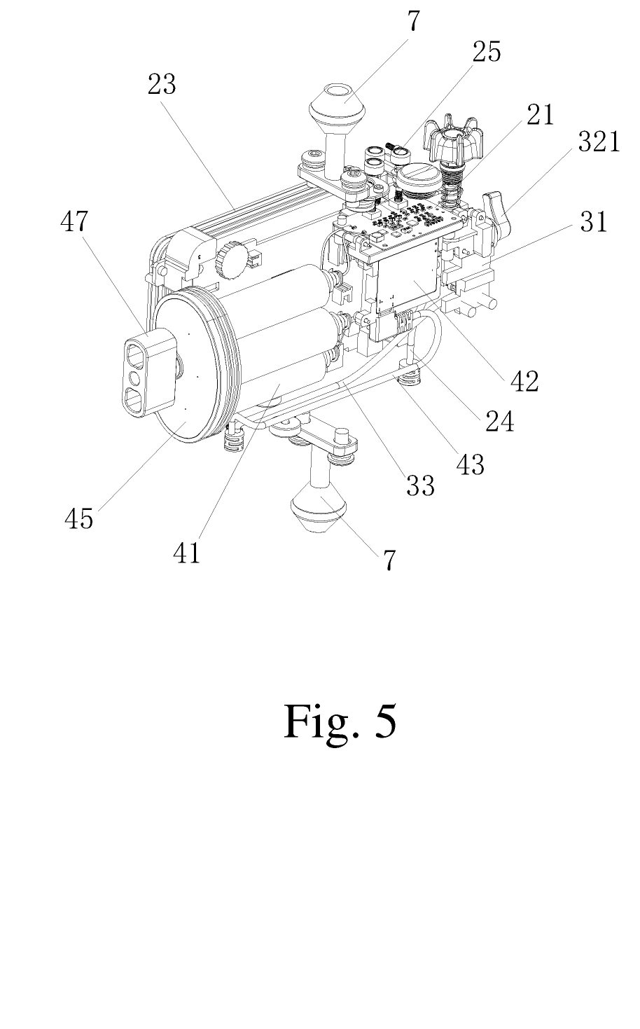

Further, with reference to FIG. 5, the monitor main body 2 includes a main control circuit board 21, a display screen control circuit board 22, a display screen 23 and a video signal line 24, the main control circuit board 21 and the display screen control circuit board 22 are both mounted in the housing 1, the display screen 23 is mounted and exposed to the housing 1, the display screen control circuit board 22 and the shutter control circuit board 31 are both electrically connected to the main control circuit board 21, and the display screen 23 is electrically connected to the display screen control circuit board 22; and one end of the video signal line 24 is connected to the display screen control circuit board 22, and the other end of the video signal line 24 penetrates the housing 1 to form the interface for connecting the camera.

Further, the monitor main body 2 further includes a monitoring adjustment button 25 having a lower end provided above the main control circuit board 21 and an upper end penetrating and exposed outside the housing 1.

In the present disclosure, one end of the video signal line 24 is connected to the camera, and the other end is connected to the display screen control circuit board 22, so as to display the display screen 23 of a real-time shooting picture transmission monitor of the camera; and the main control circuit board 21 can set the parameters of the monitor by the monitoring adjustment button 25.

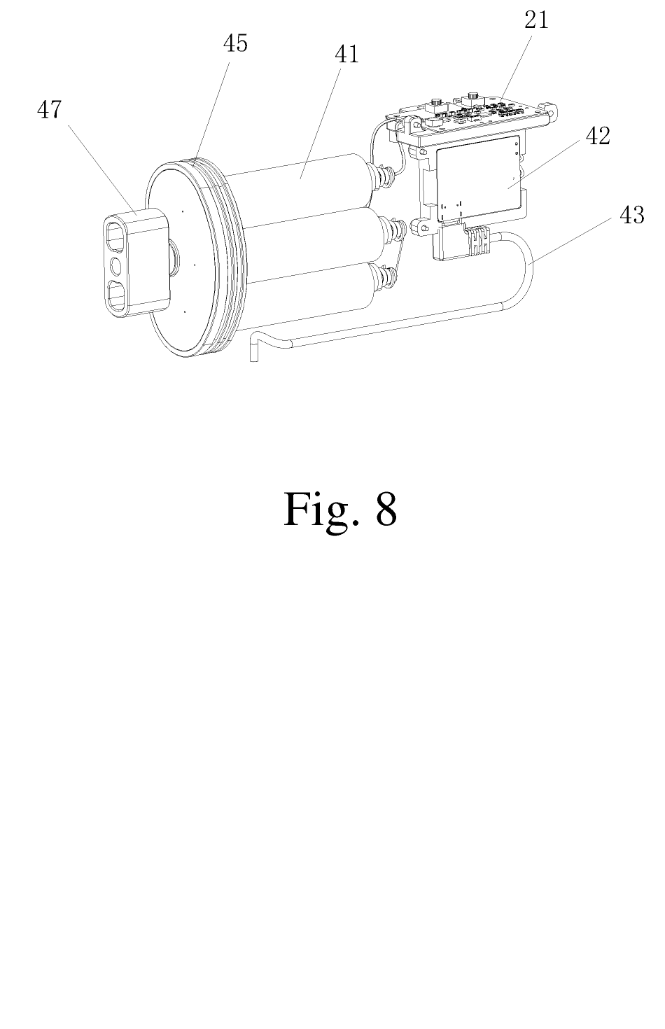

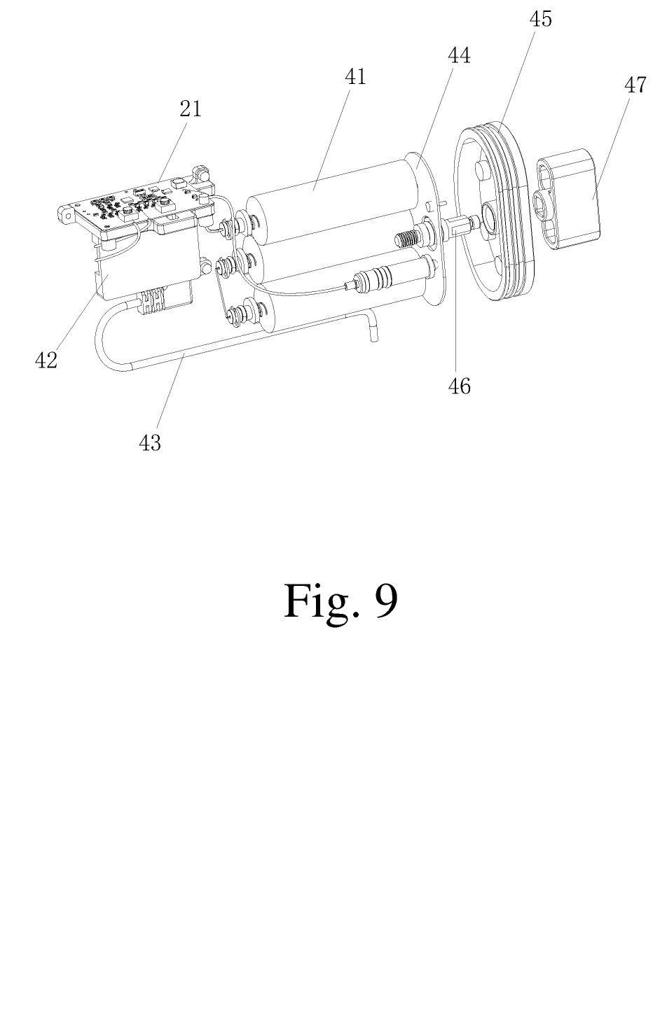

Further, with reference to FIGS. 8 and 9, the monitor further includes a power supply module 4, wherein the power supply module 4 includes a battery 41, a power supply circuit board 42 and a power supply connection line 43, and the battery 41 and the power supply circuit board 42 are both connected to the main control circuit board 21; and one end of the power supply connection line 43 is electrically connected to the power supply circuit board 42, and the other end of the power supply connection line 43 penetrates the housing 1 to form an interface for connecting a camera.

In the present disclosure, the battery 41 supplies power to the whole monitor via the main control circuit board 21, and the power supply circuit board 42 has a charging function, and can transmit the electric energy of the battery 41 to the camera via the power supply connection line 43, supply power to the camera, or charge the battery of the camera, so as to improve the endurance capability of the camera.

Further, a battery compartment 12 is further provided on the housing 1, the power supply module 4 further includes a powered PCB board 44 and a sealing rear cover 45, and the battery 41 is provided in the battery compartment 12 and is electrically connected to the main control circuit board 21; a connection port 13 is provided at an outer side of the battery compartment 12, and the powered PCB board 44 is located in the connection port 13 and is electrically connected to the battery 41 and the main control circuit board 21 so as to achieve series connection between several batteries 41; and the sealing rear cover 45 is provided on an outer side of the powered PCB board 44 and is detachably connected to an inner wall of the connection port 13.

Further, a threaded member 46 is provided on the sealing rear cover 45, a screw hole 14 is provided on the inner wall of the connection port 13, a control handle 47 is further provided on an outer side of the sealing rear cover 45, and one end of the threaded member 46 is threadedly connected to the screw hole 14 and the other end of the threaded member 46 is fixedly connected to the control handle 47.

Further, a sealing ring is provided between the sealing rear cover 45 and the inner wall of the connection port 13.

In the present disclosure, the battery 41 is mounted in the battery compartment 12 and can be locked by means of the sealing rear cover 45, and the sealing rear cover 45 is threadedly connected to the battery compartment 12 by means of a threaded member 46, such that assembly and disassembly of the sealing rear cover 45 can be facilitated. The sealing ring can improve a sealing performance of the battery compartment 12 and facilitate use of the monitor under water.

Further, a first interface 15 is provided on the housing 1, the shutter line and the power supply connection line 43 are exposed outside the housing 1 through the first interface 15, a first waterproof sleeve 5 is connected to the first interface 15, and the first waterproof sleeve 5 is sheathed outside the shutter line and the power supply connection line 43. The first waterproof sleeve 5 enables a waterproof sealing of the first interface 15 such that the monitor can be used underwater.

Further, a second interface 16 is provided on the housing 1, the video signal line 24 is exposed outside the housing 1 through the second interface 16, a second waterproof sleeve 6 is connected to the second interface 16, and the second waterproof sleeve 6 is sheathed outside the video signal line 24. The second waterproof sleeve 6 enables a waterproof sealing of the second interface 16 such that the monitor can be used underwater.

Further, both an upper end and a lower end of the housing 1 are provided with fixing members 7 for fixing the monitor to other structures.

The foregoing description is merely preferred embodiments of the present disclosure, and is not intended to limit the present disclosure. Any modifications, equivalents, improvements, etc. within the spirit and principles of the present disclosure are intended to be included within the scope of the present disclosure.

What is claimed is:

1. A monitor having a charging effect, comprising: a housing, a monitor main body and a power supply module, wherein the monitor main body is mounted to the housing, the power supply module comprises a battery, a power supply circuit board and a power supply connection line, and the battery and the power supply circuit board are both connected to the monitor main body; and one end of the power supply connection line is electrically connected to the power supply circuit board, and the other end of the power supply connection line penetrates the housing to form an interface for connecting a camera.

2. The monitor having a charging effect according to claim 1, wherein a battery compartment is further provided on the housing, the power supply module further comprises a powered PCB board and a sealing rear cover, and the battery is provided in the battery compartment and electrically connected to the monitor main body; a connection port is provided at an outer side of the battery compartment, and the powered PCB board is located in the connection port and is electrically connected to the battery and the monitor main body so as to achieve series connection between several batteries; and the sealing rear cover is provided on an outer side of the powered PCB board and is detachably connected to an inner wall of the connection port.

3. The monitor having a charging effect according to claim 2, wherein a threaded member is provided on the sealing rear cover, a screw hole is provided on the inner wall of the connection port, a control handle is further provided on an outer side of the sealing rear cover, and one end of the threaded member is threadedly connected to the screw hole and the other end of the threaded member is fixedly connected to the control handle.

4. The monitor having a charging effect according to claim 1, further comprising a shutter control module comprising a shutter control circuit board, a shutter control button, and a signal transmission unit, wherein the shutter control circuit board is mounted to the housing, the shutter control button is exposed to the housing, and the shutter control button and the signal transmission unit are both connected to the shutter control circuit board.

5. The monitor having a charging effect according to claim 4, wherein the shutter control button comprises a handle, a connection rod, a torsion spring, and a trigger, where the handle is exposed outside the housing; the connection rod is movably connected to the housing, and one end of the connection rod is fixedly connected to the handle and the other end of the connection rod is fixedly connected to the trigger; the torsion spring is sheathed on the connection rod; and one end, away from the connection rod, of the trigger is provided with a protruding post, the shutter control circuit board is provided with a control key, and the protruding post is provided opposite the control key.

6. The monitor having a charging effect according to claim 5, wherein the housing is provided with a through hole, the connection rod is provided through the through hole, and a sealing member is further provided between the through hole and the connection rod.

7. The monitor having a charging effect according to claim 5, wherein the signal transmission unit employs a shutter line, one end of the shutter line is electrically connected to the shutter control circuit board, the other end of the shutter line is provided with a shutter interface, and the shutter interface forms the interface for connecting the camera through the housing.

8. The monitor having a charging effect according to claim 4, wherein the monitor main body comprises a main control circuit board, a display screen control circuit board, a display screen and a video signal line, the main control circuit board and the display screen control circuit board are both mounted in the housing, the display screen is mounted and exposed to the housing, the display screen control circuit board, the shutter control circuit board, the battery, the power supply circuit board and the powered PCB board are all electrically connected to the main control circuit board, and the display screen is electrically connected to the display screen control circuit board; and one end of the video signal line is connected to the display screen control circuit board, and the other end of the video signal line penetrates the housing to form the interface for connecting the camera.

9. The monitor having a charging effect according to claim 7, wherein a first interface is provided on the housing, the shutter line and the power supply connection line are exposed outside the housing through the first interface, a first waterproof sleeve is connected to the first interface, and the first waterproof sleeve is sheathed outside the shutter line and the power supply connection line.

10. The monitor having a charging effect according to claim 8, wherein a second interface is provided on the housing, the video signal line is exposed outside the housing through the second interface, a second waterproof sleeve is connected to the second interface, and the second waterproof sleeve is sheathed outside the video signal line.
